(19) United States
(12) Patent Application Publication
(10) Pub. No.: US 2016/0076951 A1
(43) Pub. Date: Mar. 17, 2016

(54) CALIBRATION DEVICE AND SENSOR CALIBRATION SYSTEM USING THE SAME

(71) Applicant: HON HAI PRECISION INDUSTRY CO., LTD., New Taipei (TW)

(72) Inventor: ZONG-YUAN SUN, New Taipei (TW)

(21) Appl. No.: 14/591,154

(22) Filed: Jan. 7, 2015

(30) Foreign Application Priority Data
Sep. 12, 2014 (CN) 201410461704.9

(51) Int. Cl. G01K 19/00

(52) U.S. Cl. CPC G01K 19/00

(57) ABSTRACT

A calibration device includes a case, a connection unit, a plurality of connectors, and a controlling unit. The connection unit is exposed from the case for communicating with an operating equipment to receive at least one calibration command. The plurality of connectors are exposed from the case to couple to a plurality of sensors, respectively. The controlling unit is accommodated in the case and is coupled between the connection unit and the plurality of connectors. The controlling unit obtains at least one calibration command from the connection unit and transmits the at least one calibration command to the plurality of sensors to synchronously check and calibrate the plurality of sensors.

### FIELD

The subject matter herein generally relates to calibration systems, and particularly to a calibration device and a sensor calibration system using the same.

### BACKGROUND

To facilitate and extend a shelf life of products, such as, for example, chemicals, foods, and pharmaceutical drugs, from manufacture through distribution, a temperature-controlled supply chain (sometimes referred to as a cold chain) is required. Generally, the cold chain includes a large number of temperature sensors. For the cold chain to be safe, an operator must frequently check and calibrate each temperature sensor, and calibration must be done quite frequently in order to insure an accuracy of the temperature sensors.

### BRIEF DESCRIPTION OF THE DRAWINGS

Implementations of the present technology will now be described, by way of example only, with reference to the attached figures.

FIG. 1 is a block diagram of a sensor calibration system employing a calibration device, according to an exemplary embodiment.

FIG. 2 is an assembled, isometric view of the calibration device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a calibration device and a sensor calibration system using the same.

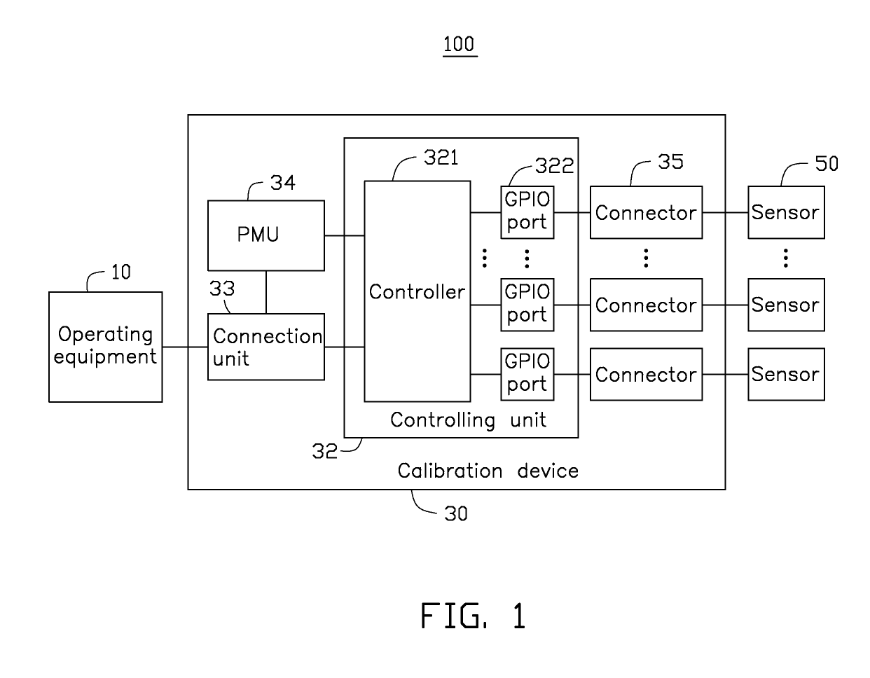

FIG. 1 illustrates an embodiment of a sensor calibration system 100, according to an exemplary embodiment. The sensor calibration system 100 includes an operating equipment 10 and a calibration device 30 communicating with the operating equipment 10.

In at least one embodiment, the operating equipment 10 can be a desktop computer. A temperature calibration software is embedded in the operating equipment 10, and at least one calibration command is pre-stored in the temperature calibration software for controlling the calibration device 30.

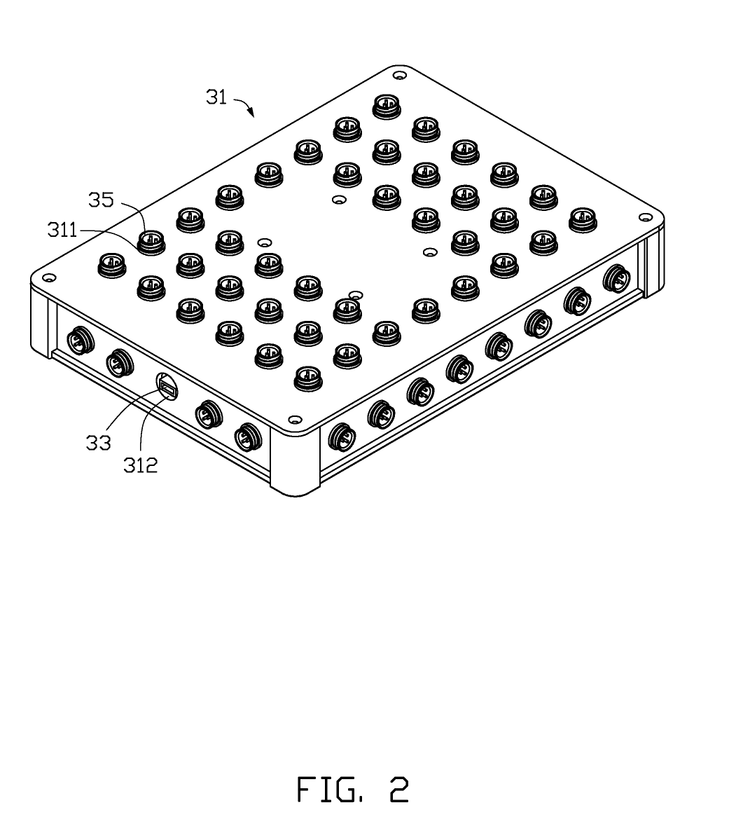

The calibration device 30 includes a case 31 (see FIG. 2), a controlling unit 32, a connection unit 33, a power management unit (PMU) 34, and a plurality of connectors 35. In at least one embodiment, the controlling unit 32 and the PMU 34 are accommodated in the case 31. The connection unit 33 is electronically coupled to the controlling unit 32 and the PMU 34 and is exposed from the case 31 for communicating with the operating equipment 10. The plurality of connectors 35 are electronically coupled to the controlling unit 32 and are exposed from the case 31 for engaging with a plurality of sensors 50, such as temperature sensors, humidity sensors, smoke sensors, or proximity sensors.

FIG. 2 illustrates the case 31 defining a plurality of first holes 311 and a second hole 312. The plurality of first holes 311 are defined at a top wall and four side walls of the case 31 to secure the plurality of connectors 35. The second hole 312 is defined at one of the four side walls of the case 31 to secure the connection unit 33.

The connection unit 33 can be a universal serial bus (USB) connector, which is exposed through the second hole 312 for electronically coupling to the operating equipment 10 via a USB cable (not shown). Thus, the controlling unit 32 can obtain the calibration command from the operating equipment 10 via the connection unit 33. In addition, the connection unit 33 may receive power from the operating equipment 10 to drive the calibration device 30. In other embodiments, the connection unit 33 can also be a wireless communication module, such as a BLUETOOTH® module. Thus, a wireless communication can be established between the connection unit 33 and the operating equipment 10, and consequently the USB cable can be omitted, and the calibration device 30 can be powered by an external power supply.

The controlling unit 32 includes a controller 321 having a plurality of general purpose input/output (GPIO) ports 322, and the plurality of GPIO ports 322 are electronically coupled to the plurality of connectors 35, respectively. Thus, the controller 321 can transmit the calibration command to the sensors 50. In at least one embodiment, the controller 321 can be a signal chip microcontroller having sixty-four GPIO ports, and the number of the connectors 35 is also sixty-four. Thus, each connector 35 can be electronically coupled to each GPIO port 322, respectively. Optionally, the connector 35 can be a socket, and the sensor 50 may have a plug engaging with the socket. In other embodiments, the controlling unit 32 further includes a reset circuit, a crystal oscillation circuit, a filter circuit, and other fundamental circuits.

The PMU 34 is electronically coupled between the connection unit 33 and the controlling unit 32 to convent the power received by the connection unit 33 into a driving voltage of the controlling unit 32. In at least one embodiment, the PMU 34 is a direct current-direct current (DC-DC) converter, for example, the connection unit 33 obtains a power of about 5V from the operating equipment 10, and then the PMU 34 outputs a driving voltage of about 3.3V to the controlling unit 32.

In summary, the sensor calibration system 100 includes the plurality of connectors 35 electronically coupled to the plurality of GPIO ports 322 of the controlling unit 32, and then the controlling unit 32 can transmit the calibration command to the plurality of sensors 50 to synchronously check and calibrate the plurality of sensors 50 for insuring an accuracy of the plurality of sensors 50. Thus, the sensor calibration system 100 is efficient.

The embodiments shown and described above are only examples. Many details are often found in the art such as the other features of the calibration device and the sensor calibration system using the same. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A calibration device for calibrating a plurality of sensors comprising:
a case;
a plurality of connectors respectively exposed through a plurality of first holes formed in the case and configured to be coupled to a plurality of sensors, respectively;
a connection unit exposed through a second hole formed in the case and configured to receive at least one calibration command; and
a controlling unit accommodated in the case and coupled between the connection unit and the plurality of connectors;
wherein the controlling unit obtains at least one calibration command from the connection unit and transmits the at least one calibration command to the plurality of sensors to synchronously check and calibrate the plurality of sensors.

2. The calibration device as claimed in claim 1, wherein the controlling unit comprises a controller having a plurality of general purpose input/output (GPIO) ports, and the plurality of GPIO ports are electronically coupled to the plurality of connectors, respectively.

3. The calibration device as claimed in claim 1, wherein the connection unit is a universal serial bus (USB) connector, and the connection unit receives power from the operating equipment.

4. The calibration device as claimed in claim 3, further comprising a power management unit (PMU) coupled between the connection unit and the controlling unit, wherein the PMU convents the power received by the connection unit into a driving voltage of the controlling unit.

5. The calibration device as claimed in claim 1, wherein the connection unit is a wireless communication module.

6. A sensor calibration system for calibrating a plurality of sensors, the sensor calibration system comprising:
an operating equipment pre-storing at least one calibration command;
a calibration device comprising:
a connection unit coupled to the operating equipment to receive the at least one calibration command;
a plurality of connectors configured to couple to the plurality of sensors, respectively; and
a controlling unit coupled between the connection unit and the plurality of connectors;
wherein the controlling unit obtains at least one calibration command from the connection unit and transmits the at least one calibration command to the plurality of sensors to synchronously check and calibrate the plurality of sensors.

7. The sensor calibration system as claimed in claim 6, wherein the controlling unit comprises a controller having a plurality of general purpose input/output (GPIO) ports, and the plurality of GPIO ports are electronically coupled to the plurality of connectors, respectively.

8. The sensor calibration system as claimed in claim 6, wherein the connection unit is a universal serial bus (USB) connector, and the connection unit receives power from the operating equipment.

9. The sensor calibration system as claimed in claim 8, wherein the calibration device further comprises a power management unit (PMU) coupled between the connection unit and the controlling unit, the PMU convents the power received by the connection unit into a driving voltage of the controlling unit.

10. The sensor calibration system as claimed in claim 9, wherein the calibration device further comprises a case, the connection unit and the plurality of connectors are exposed from the case, and the controlling unit and the PMU are accommodated in the case.

11. The sensor calibration system as claimed in claim 10, wherein the case defines a plurality of first holes and a second hole, the plurality of connectors are secured in the plurality of first holes, and the connection unit is secured in the second hole.
